(19) United States
(12) Patent Application Publication
(10) Pub. No.: US 2009/0166129 A1
(43) Pub. Date: Jul. 2, 2009

(54) Power retractable stairway

(75) Inventors: Ernest Ray Siler, Bradenton, FL (US); Jennie Lee Siler, Bradenton, FL (US)

Correspondence Address: Ernest Ray Siler, Unit 401, 7710 Lake Vista Court, Bradenton, FL, 34202, US

(73) Assignees: Ernest Ray Siler, Bradenton, FL (US); Jennie Lee Siler, Bradenton, FL (US)

(21) Appl. No.: 12/004,995

(22) Filed: Dec. 26, 2007

(51) Int. Cl. E06C 1/383

(52) U.S. Cl. 182/158

(57) ABSTRACT

A retract and pivot stairway assembly includes a drive and pivot mechanism, a stairway assembly and an opening cover. The operation is controlled with a push button wall switch that controls the drive mechanism. The drive mechanism uses rack and pinion gearing to retract and pivot the stairway. The stairway is guided on rollers on a pivot devices. The pivot devices also serve as a mounting apparatus for the opening cover. An emergency feature is provided with a guide bracket and hand crank.

The stairway approaches as a stairway and not a ladder. It has wide steps and a full length hand rail on one side. There is an emergency feature provided to extend and pivot down the stairway using a worm screw and bracket pilot with a support and access hole for it.

### TECHNICAL FIELD

### Power Retractable Stairway

The present application relates generally to attic access, with a ladder, and more particularly to a non folding stairway that can be easily retracted and stored.

### BACKGROUND

Various types of ladder systems are available that are used for access to attics. Such systems include, for example, wood folding ladders, telescoping ladders, scissor system type ladders to name a few. These above mentioned systems are ladders that requires a high climb angle from vertical and is usually not a solid built construction because it folds or collapses for storage. All of the systems, that I am aware of, are not suited for easy use. In addition, the above mentioned systems are limited on access and step width which limits access.

The proposed stairway system is of rigid construction. It does not fold or collapse for storage. When it is pivoted and extended into a usable position it has a rise angle of 45 degrees and is used as a staircase. An electric motor drives the stairway from the stored position to pivoted down and extended position. An electric motor drives the stairway through a simple gear train. The gear train is a shaft, with three gears and one gear pulley that is driven with a gear belt from the motor. Power to the electric motor is controlled with a push button electric box on the wall. Pinion gears engage the stairway through racks that are mounted on the lower side of each stringer to drive the stairway. Stringer is the term used in the ladder or stairway industry to refer to sides that the steps are attached to. A center gear engages the center rack, which is attached to the steps, to resist causing the pivoting of the stairway closed. A limit switch is positioned to turn off the motor when the stairway is pivoted closed. In case of a power failure, the stairway can be manually pivoted and extended with a mechanical crank after releasing the brake on the motor which is provided with the purchased gear motor. The brake is released by pulling a cable attached to a spring brake. This system is modular and is mounted directly into an existing home with code specified rafter spacing.

### BRIEF DESCRIPTION OF THE 3-D DRAWINGS

FIG. 1 is a 3-d CAD view of an embodiment of a power retractable stairway positioned in the retracted and pivoted Into the stored position.

FIG. 2 is a 3-d CAD view of an embodiment of a power retractable stairway positioned in the pivoted down and extended position.

FIG. 2.1 section A-A is a section view of an embodiment of the drive train as view from the left side with the drive sequence train from the motor through retracting and pivoting the staircase.

FIG. 2.2 section B-B is a picture view of an embodiment of the stairway tracks on the pivot bracket rollers with the drive pinion meshed with the stairway rack.

FIG. 3 is a 3-d CAD view of Drive & pivot Assembly Modular unit.

FIG. 3.1 Partially Exploded view of an embodiment of a pivot assembly.

FIG. 3.2 (EMERGENCY CRANK ENGAGED) is a 3-d CAD view of the embodiment of the emergency crank engage

FIG. 3.3 (LOWER RETAINING PLATE) is a 3-d CAD view of the embodiment of lower retaining plate.

FIG. 4 is a 3-d CAD view of the embodiment of the stairway

FIG. 4.1 is a 3-d CAD view of the embodiment of the top end of the stairway assembly.

FIG. 5 is a 3-d CAD view of the embodiment of the cover assembly.

FIG. 5.1 is a 3-d CAD view of the embodiment of the Roe Ends.

### DETAILED DESCRIPTION

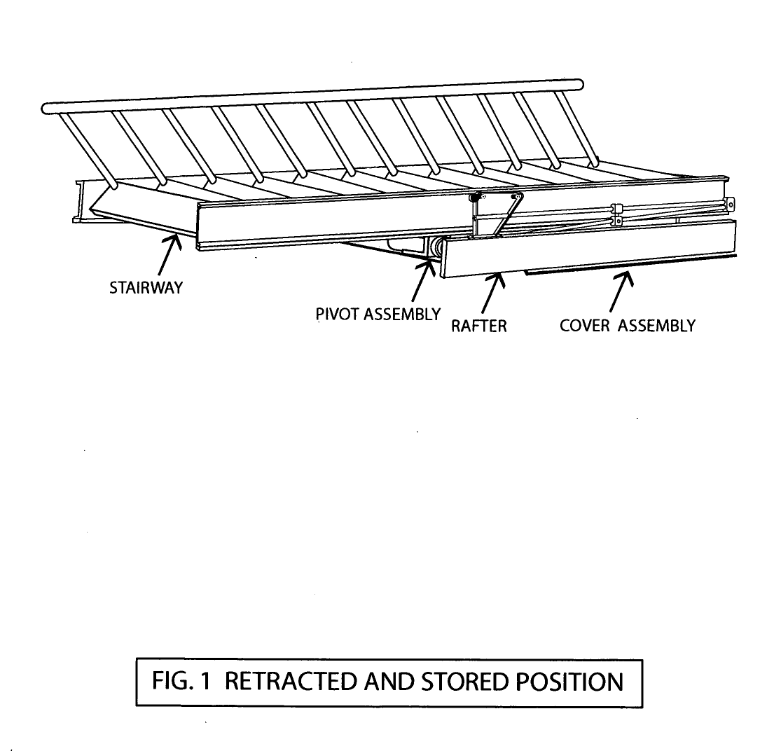

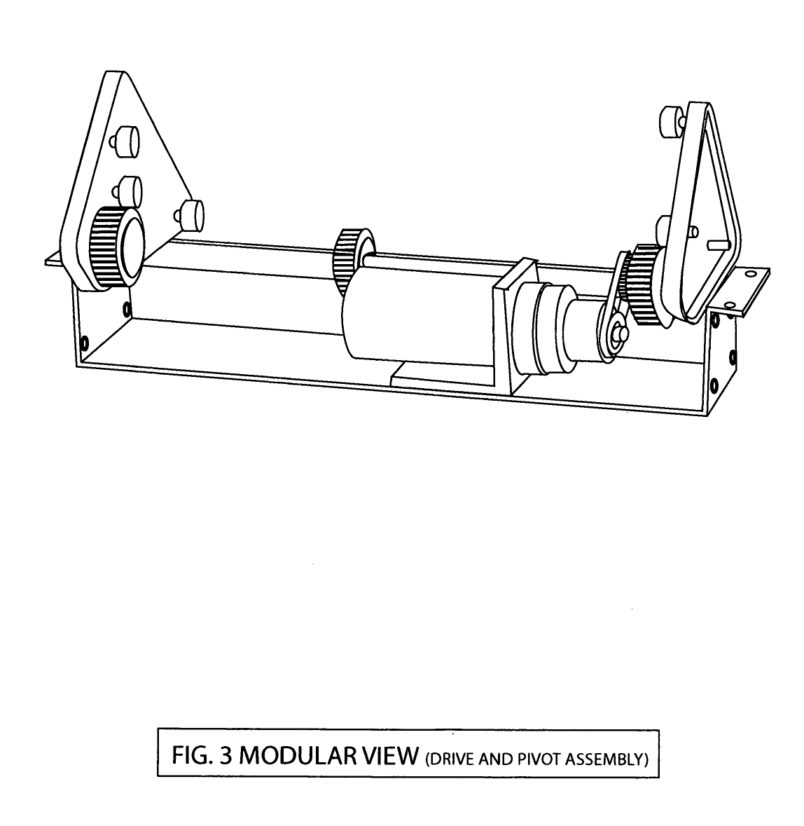

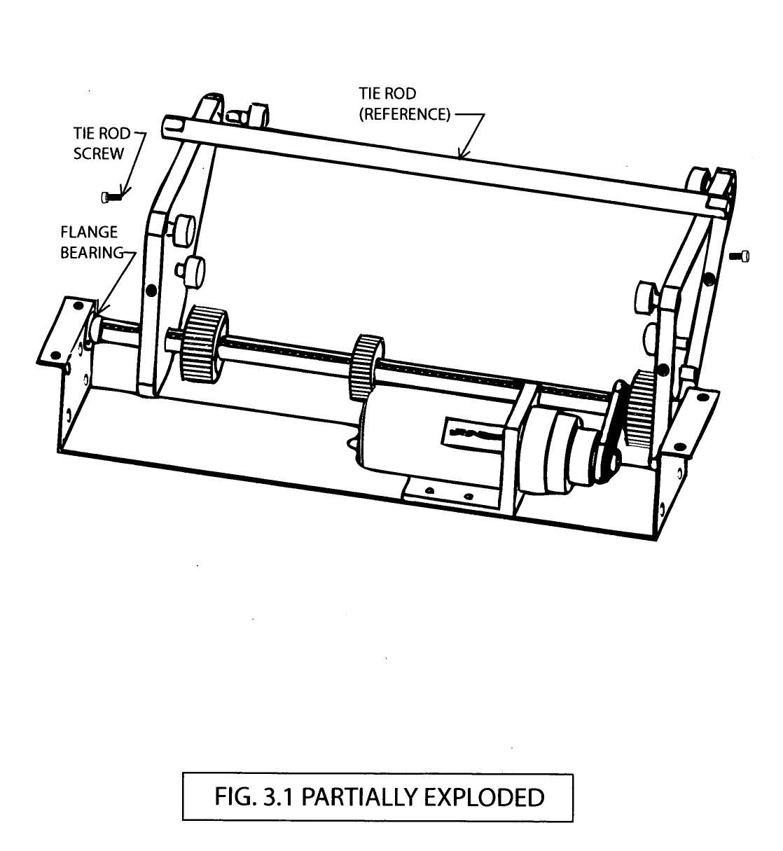

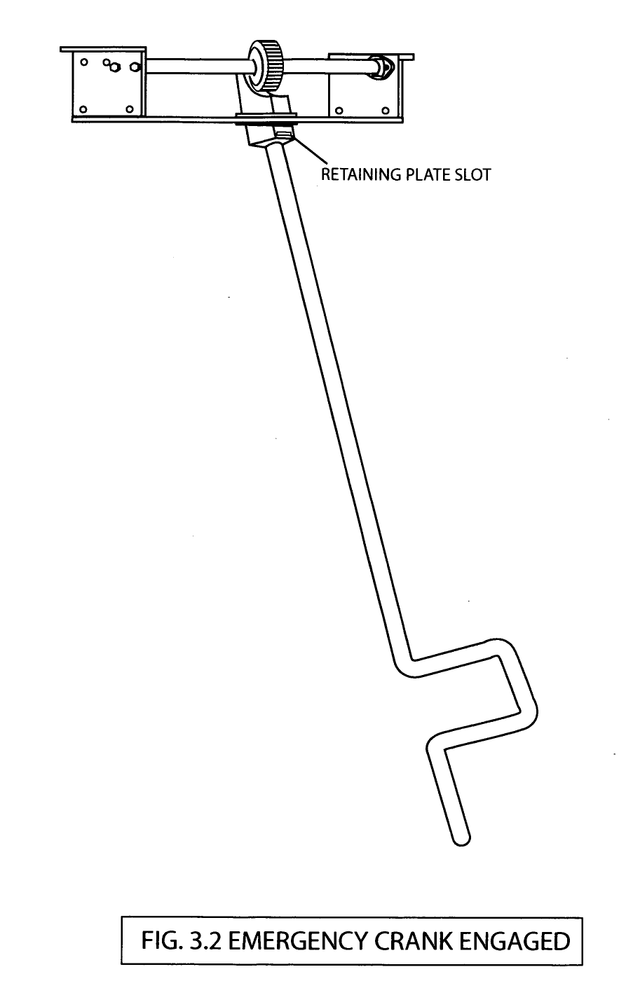

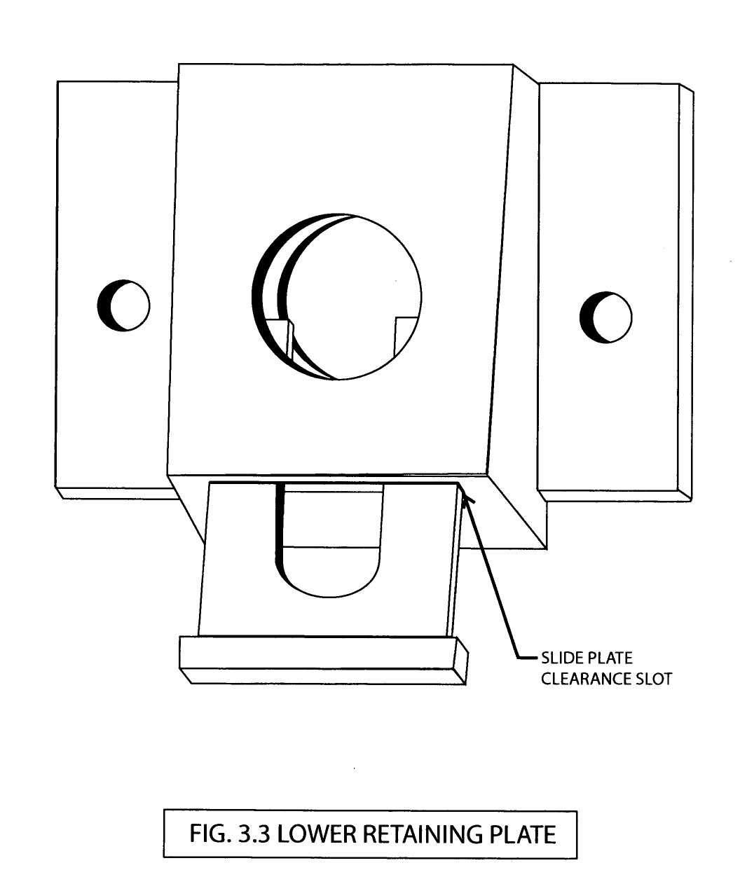

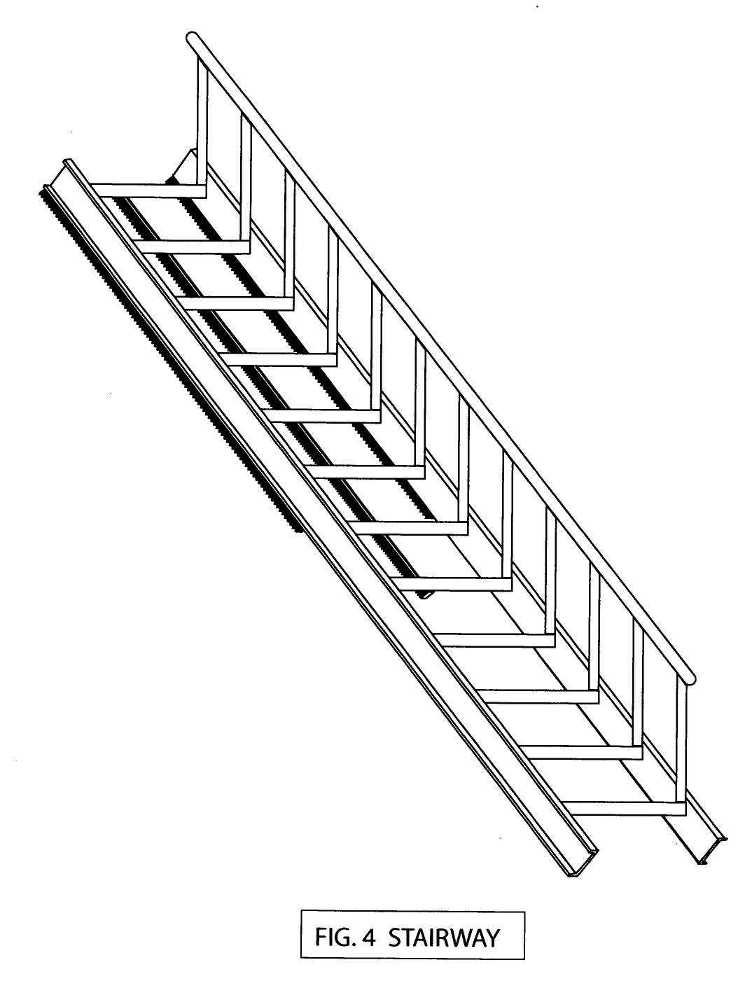

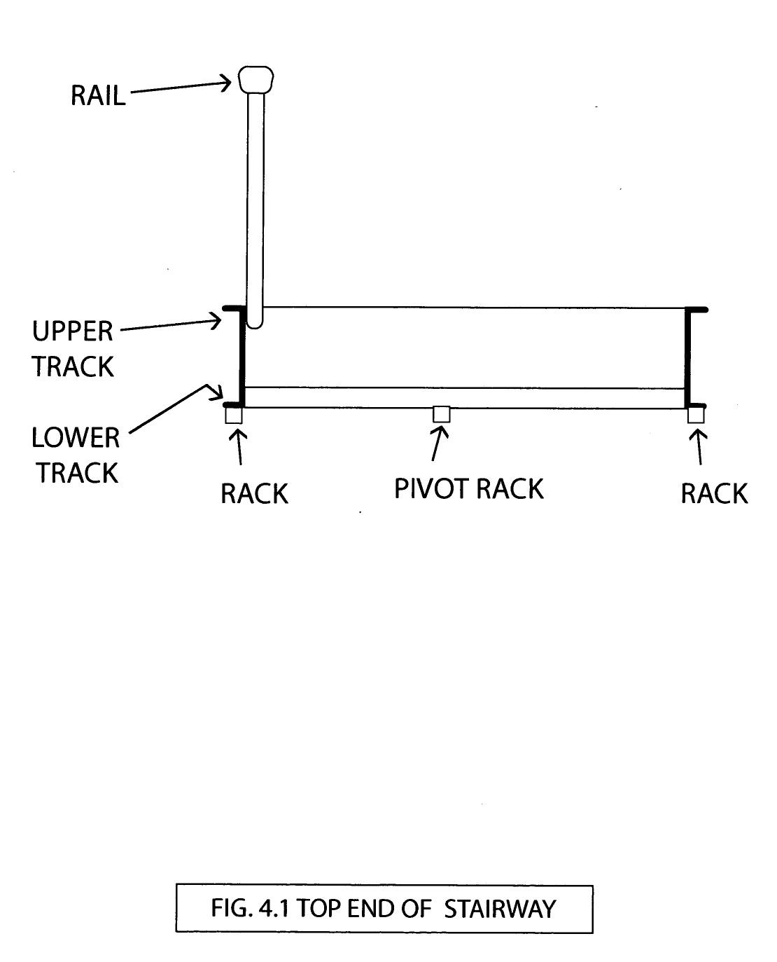

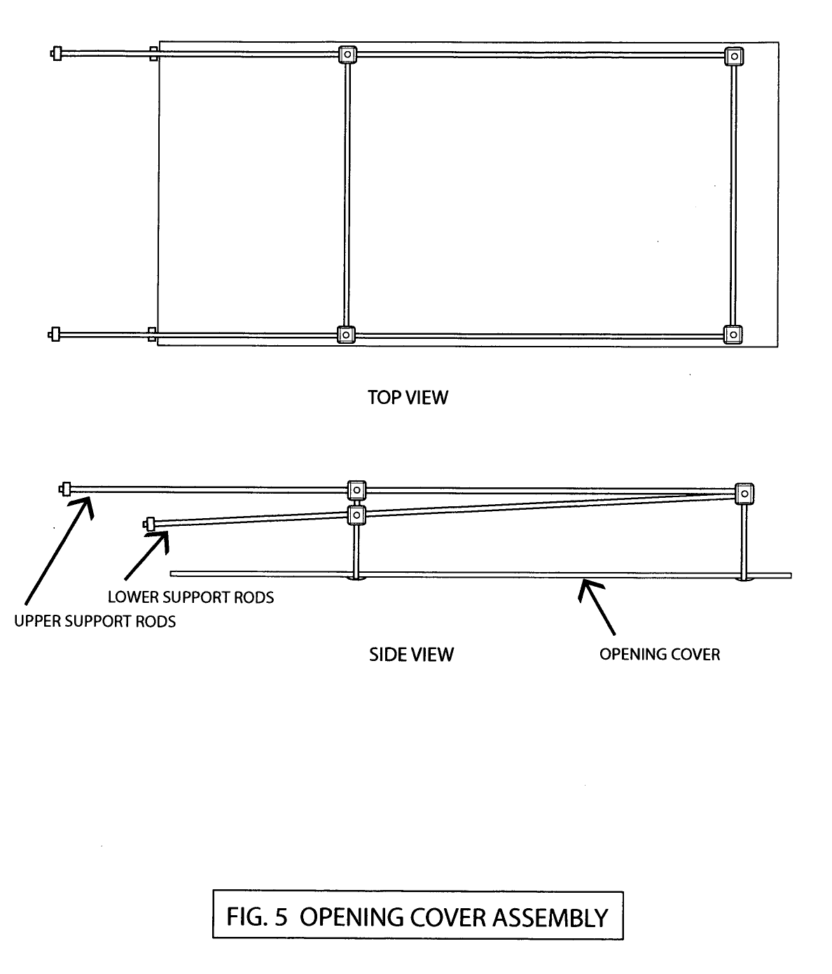

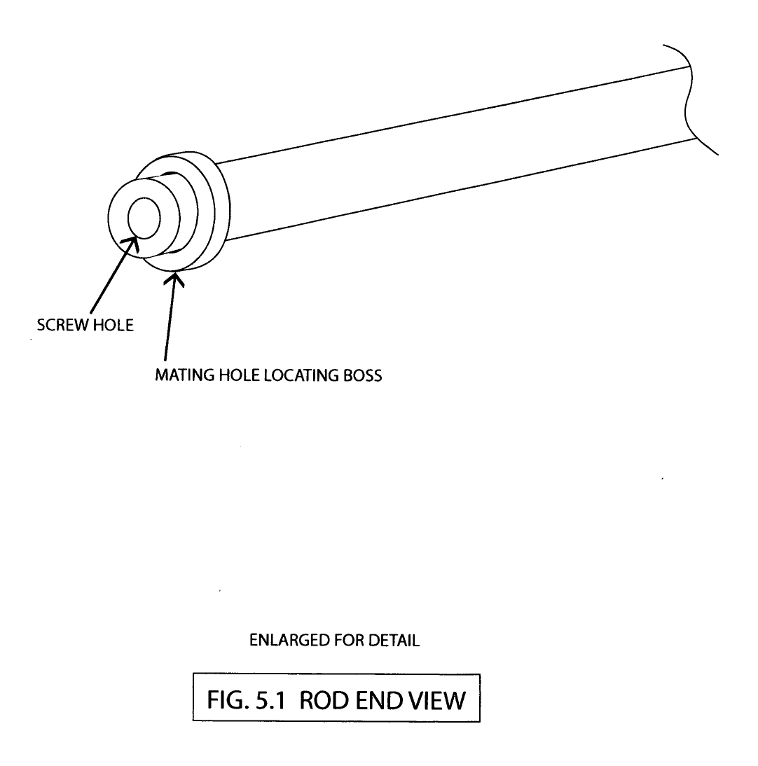

Referring to FIG. 1, an embodiment of a power retractable stairway includes a stairway assembly (shown in FIG. 4) driven by the drive assembly (shown in FIG. 3), an opening cover (shown in FIG. 5). FIG. 1 also shows rafters as a source, but not to be limited to, for anchoring the drive assembly.

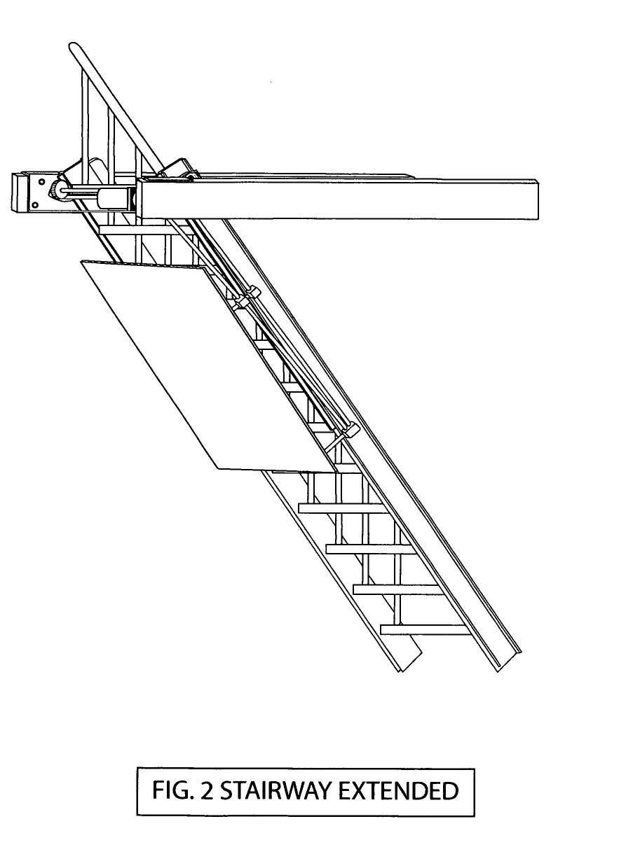

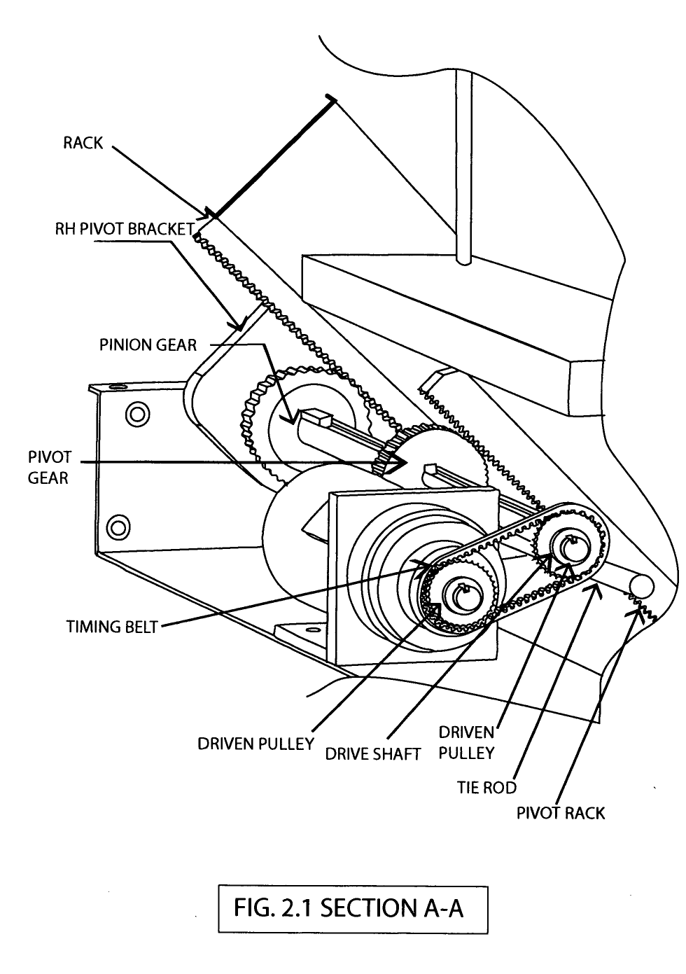

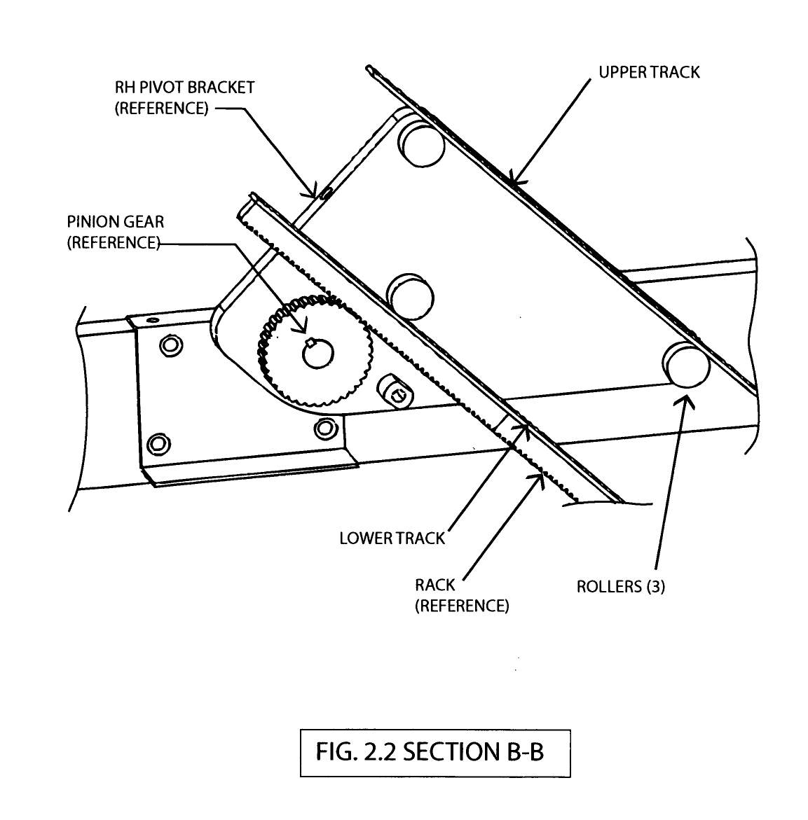

Referring to FIG. 2, represents the embodiment shown in FIG. 1 with the stairway extended and pivoted down for the purpose of use. The opening cover is suspended below the staircase so that it is flush with the ceiling in the closed position as shown in FIG. 1. FIG. 2 also shows the position of section views A-A and B-B shown in FIG. 2.1 section A-A and FIG. 2.2 section B-B.

Referring to FIG. 2.1 SECTION A-A, which represents a section view of the embodiment of the drive assembly consisting of a gear train. The gear train includes an electric gear motor that drives a drive pulley that has a timing belt connected to a driven pulley which is fixed to a drive shaft. The drive shaft has two pinion gears and one pivot gear. Pinion gears drive the outside racks attached to the stringers and a pivot gear drives the center rack attached to the stairway assembly steps.

Referring to FIG. 2 section B-B, the stairway has upper and lower tracks that are carried on rollers. Rollers are housed in pivot brackets located on each side of the stairway. Left (LH) and right (RH) pivot brackets pivot freely on the drive shaft. The drive shaft is supported by flange bearings that are attached on left and right sides of the hang bracket. One flange bearing is shown attached to the hang bracket in FIG. 3.1. The pivot assembly is caused to pivot by the pinion gear driving the outside racks faster than the pinion gear driving the center rack. The pivot gear is on the same drive shaft as the pinion gears therefore it turns at the same RPM. The circumference of the pitch diameter (PD) of the pivot gear is 87% of the circumference of the pinion gear PD. This differential in circumference causes the pinion gear to torque against the resistance of the pivot gear that is moving through less linear distance per revolution. The difference in this linear distance is compensated by pivoting the racks about the pinion gears. Racks are fastened to the stairway which is guided by the said pivot brackets. The pivot gear is sized proportionally smaller to require the pivot bracket to rotate the proper number of degrees to close, to storage position, when the stairway retraction is completed by the pinion gears. In the closed position the cover assembly closes the opening. Cover assembly is attached to the pivot brackets and suspended below the he outside gear racks attached to the stairway assembly. The pivot gear drives the stairway the distance required to match the ceiling.

Referring to FIG. 3 is an embodiment of the drive assembly that shows it in a modular assembly that would simplify installation for someone that does their own home rebuilding projects.

Referring to FIG. 3.1 partially exploded view of the drive assembly with the flange bearings, the tie rod that keeps the LH pivot bracket and RH pivot bracket tie together for support an position. It also shows a shoulder (roller flange) that is tightened to the face of the pivot bracket to give additional support to the roller.

Referring to FIG. 3.2 Emergency Crank Section View which shows an emergency crank bracket that provides an access hole with a smaller pilot hole continuing through the bracket. An emergency crank screw with a smaller boss extends through the smaller pilot hole of the bracket. This provides a worm screw and pinion to be used in case of an emergency to extend and pivot down the stairway. A lower bracket attached below the plate has a slot for slide plate with a yoke shape. This yoke shape is a clearance for the crank diameter while the sides of the yoke supports the thrust from the worm screw driving the gear.

Referring to FIG. 4 Stairway shows the embodiment of the stairway especially made for the power retractable stairway. A hand rail is provide for only one side to allow more access.

Referring to FIG. 4 Top End Of Stairway that shows extruded tracks on the stringers with the outside racks attached to them. It also shows a center rack attached to the steps.

1. A retractable stairway apparatus comprising:
a) a stairway including multiple gear racks to retract a stairway to a position of storage using a
b) drive mechanism such as, but not limited to, an electric motor attached to a mounting device and
c) an opening cover device

2. The drive mechanism in claim 1, wherein the drive shaft of the said drive mechanism is attached to a pinion drive gear which is meshed to the first and third said rack of the stairway also in claim 1.

3. A pivot pinion gear is driven by the said drive shaft in claim 2 and is meshed with the second rack device of the stairway in claim 1 by the gearing of the said drive mechanism and the retracting drive gear is larger than the pivot pinion gear therefore forcing the multiple racks to pivot around the radii of the drive pinion and pivot pinion gears.

4. Pivoting devices, that freely rotate on the drive shaft and are connected with a round bar, include roller guiding devices that guide the direction of the said stairway and provide a mounting feature for the opening cover assembly.

5. A bracket device is attached to said mounting device in claim 1 to provide a guide mechanism for operating the said stairway apparatus manually for emergency purposes. The bracket device serves as a guide to a hand held crank mechanism with a worm screw socket where the bracket device serves as a guide and axial support.
